(19) United States
(12) Patent Application Publication
(10) Pub. No.: US 2018/0083237 A1
(43) Pub. Date: Mar. 22, 2018

(54) CONNECTOR FOR LIQUID COOLING BATTERY PACK OF ELECTRIC VEHICLE

(71) Applicant: NIO NEXTEV LIMITED, Hong Kong (CN)

(72) Inventors: Linfeng WANG, Shanghai (CN); Hui QI, Shanghai (CN); Jie FANG, Shanghai (CN); Zhanyu FU, Shanghai (CN); Bo LI, Shanghai (CN)

(21) Appl. No.: 15/710,995

(22) Filed: Sep. 21, 2017

(30) Foreign Application Priority Data
Sep. 21, 2016 (CN) 201621070746.0

(51) Int. Cl. H01M 2/10; H01M 2/04; H01M 2/36; H01M 2/24

(52) U.S. Cl. CPC H01M 2/1016; H01M 2/24; H01M 2/36; H01M 2/0443

(57) ABSTRACT

A connector for liquid cooling battery pack of electric vehicle is provided. The connector comprises mounting plates and electrical terminals and cooling device interfaces disposed on the mounting plates. The connector further includes sealing shells disposed on the mounting plates, the electrical terminals are separated from the cooling device interfaces by the sealing shells. The connector of the application has the advantages of higher integration level, reduced weight, water and electricity separation, etc., so that it can be installed quickly and much cost effectively.

### CROSS-REFERENCE TO RELATED APPLICATION

This application claims the benefit of China Patent Application No. 201621070746.0 filed Sep. 21, 2016, the entire contents of which are incorporated herein by reference.

### TECHNICAL FIELD

The present application relates to the field of electric vehicle, particularly to a connector for liquid cooling battery pack of electric vehicle.

### BACKGROUND

Popularity of new energy vehicles-especially electric-only vehicles is promptly increased over the past two years in china as more supportive policies are issued by governments, making the market share of electric-only vehicles bigger and bigger. As an important component of electric vehicle, liquid cooling battery pack has such problems as time-consuming recharging, shortage of battery charging station, time-consuming replacement and shortage of battery swapping station, by which the development of electric vehicles is constrained.

Generally speaking, a connector of the liquid cooling battery pack of a traditional electric vehicle comprises high voltage electrical connecting terminals, low voltage electrical connecting terminals and cooling device interfaces. The high voltage electrical connecting terminals serve as battery pack energy input and/or output interfaces; the low voltage connecting terminals serve as low voltage power supply and communication interfaces of a battery pack; and the cooling device connectors serve as cooling liquid input and/or output interfaces of a battery pack. For the sake of accurate and reliable connection of these terminals and interfaces, each of them has a locking device, a positioning system, a floating system and a detecting system, as a result of which the whole connector has the disadvantages of lower integration level, heavy weight, higher cost and being unable to be installed quickly and automatically in case of manual operation during install and detach.

Accordingly, there is a need for a new connector for liquid cooling battery pack of electric vehicle to resolve the previously mentioned problems.

### SUMMARY OF THE APPLICATION

To resolve the above problems in the art, i.e., the problem that the existing connector is of lower integration level, heavy weight, higher cost and being unable to be installed quickly and automatically, the application provides a connector for liquid cooling battery pack of electric vehicle. The connector comprises mounting plates and electrical terminals and cooling device interfaces located on the mounting plates.

According to the connector for liquid cooling battery pack of electric vehicle, optionally, the connector further includes sealing shells disposed on the mounting plates, the electrical terminals are separated from the cooling device interfaces by the sealing shells.

According to the connector for liquid cooling battery pack of electric vehicle, optionally, the electrical terminals include high voltage terminals, low voltage terminals and grounding terminals situated within the sealing shells, and the cooling device interfaces are situated outside the sealing shells.

According to the connector for liquid cooling battery pack of electric vehicle, optionally, the connector also includes guide mechanisms, which are located on the mounting plates and outside the sealing shells.

According to the connector for liquid cooling battery pack of electric vehicle, optionally, the connector also includes floating mechanisms, which are located on the mounting plates and outside the sealing shells.

According to the connector for liquid cooling battery pack of electric vehicle, optionally, the connector includes a battery pack end and a wiring harness end, and the mounting plates include a battery pack end mounting plate and a wiring harness end mounting plate.

According to the connector for liquid cooling battery pack of electric vehicle, optionally, the high voltage terminals include first high voltage terminals disposed on the battery pack end mounting plate and second high voltage terminals disposed on the wiring harness end mounting plate and mating with the first high voltage terminals.

According to the connector for liquid cooling battery pack of electric vehicle, optionally, the low voltage terminals include first low voltage terminals disposed on the battery pack end mounting plate and second low voltage terminals disposed on the wiring harness end mounting plate and mating with the first low voltage terminals.

According to the connector for liquid cooling battery pack of electric vehicle, optionally, the grounding terminals include a first grounding terminal disposed on the battery pack end mounting plate and a second grounding terminal disposed on the wiring harness end mounting plate and mating with the first grounding terminal.

According to the connector for liquid cooling battery pack of electric vehicle, optionally, the cooling device interfaces include first cooling device interfaces disposed on the battery pack end mounting plate and second cooling device interfaces disposed on the wiring harness end mounting plate and mating with the first cooling device interfaces.

According to the connector for liquid cooling battery pack of electric vehicle, optionally, the sealing shells include a first sealing shell disposed on the battery pack end mounting plate and a second sealing shell disposed on the wiring harness end mounting plate and mating with the first sealing shell.

According to the connector for liquid cooling battery pack of electric vehicle, optionally, the guide mechanisms include first guide mechanisms disposed on the battery pack end mounting plate and second guide mechanisms disposed on the wiring harness end mounting plate and mating with the first guide mechanisms.

According to the connector for liquid cooling battery pack of electric vehicle, optionally, the floating mechanisms are disposed on the wiring harness end mounting plate.

According to the connector for liquid cooling battery pack of electric vehicle, optionally, the high voltage terminals, the low voltage terminals, the cooling device interfaces, the sealing shells and the floating mechanisms are disposed on the mounting plates symmetrically with reference to the central axis of their respective mounting plate, and the guide mechanisms are disposed on the mounting plates asymmetrically with reference to the central axis of their respective mounting plate.

According to the connector for liquid cooling battery pack of electric vehicle, optionally, the grounding terminals are disposed at the centers of the mounting plates and the centers of the sealing shells.

According to the connector for liquid cooling battery pack of electric vehicle, optionally, each set of low voltage terminals includes a first low voltage needle-like end and a second low voltage needle-like end, each set of second low voltage terminals includes a first low voltage hole end mating with the first low voltage needle-like end and a second low voltage hole end mating with the second low voltage needle-like end.

According to the connector for liquid cooling battery pack of electric vehicle, optionally, the vertical height of the first guide mechanisms is higher than that of the first grounding terminal, the vertical height of the first grounding terminal is higher than that of the first high voltage terminals, the vertical height of the first high voltage terminals is higher than that of the first cooling device interfaces, the vertical height of the first cooling device interfaces is the same as that of the first low voltage needle-like end, and the vertical height of the first low voltage needle-like end is higher than that of the second low voltage needle-like end.

According to the connector for liquid cooling battery pack of electric vehicle, optionally, the first sealing shell is provided with a gasket ring at its periphery in contact with the battery pack end mounting plate; and/or the top surfaces of the first high voltage terminals are made from insulation material; and/or each first cooling device interface is provided with a cut-off valve.

It could be understood by those skilled in the art that, the electrical terminals and the cooling device interfaces are integrated on a same mounting plate, and share a set of interface shells, a positioning system, a floating system and a system for detecting the connection, such that the whole connector has the advantages of higher integration level, reduced weight, realizing the possibility of quickly swapping battery in a much cost effective manner.

It could also be understood by those skilled in the art that, the sealing shells are designed to separate the electrical system and the cooling device interfaces on a same mounting plate from one another, so as to achieve water and electricity separation. In addition, the insulation material on the top of the high voltage terminals helps in realizing anti-finger-contact function of IPxxB. Furthermore, the cut-off valves of the cooling device interfaces allow cooling liquid to pass through as the interfaces are connected and prevent cooling liquid from running through as the interfaces are disconnected. Finally, since the first guide mechanisms and the two second guide mechanisms are asymmetrically disposed around the central axis of their respective mounting plate (specifically disposed on the same side of the diagonal line of the mounting plate), Fooling-proof function is realized for the connector during connection.

### BRIEF DESCRIPTION OF DRAWINGS

FIG. 1 is a schematic illustration of a battery pack end of the connector for liquid cooling battery pack of electric vehicle in accordance with the present application;

FIG. 2 is a schematic illustration of the wiring harness end of the connector for liquid cooling battery pack of electric vehicle in accordance with the present application; and

FIG. 3 is a view showing the sequential order of connecting the components of the connector for liquid cooling battery pack of electric vehicle in accordance with the present application.

### DETAILED DESCRIPTION

The preferred embodiments of the present application will be described below with reference to the accompanying figures. As will be understood by those skilled in the art, these embodiments are merely used for interpreting the technical principle of the present application and are not intended to limit its protection scope in any way. For example, although the two guide posts in the figures are cylindrical in shape and located outside the sealing shell, the number, shape and location of the guide post(s) are merely exemplary in nature and can be modified as desired to accommodate specific applications by those skilled in the art.

It should be noted that, in the description of the present application, the usage of such directional and positional terms as central, upper, lower, left, right, vertical, horizontal, inner and outer, is based on the directional and positional relations shown in the drawings, and used to facilitate the description itself and does not express or imply the necessary specific positions or specific operational and structural positions of the devices or elements of the disclosure. Therefore, the usage is not to be understood as limitation on the present application. Additionally, terms first, second and third are merely provided for the purposes of description rather than expressing or implying their relative importance.

Moreover, it should also be noted that, in the description of the present application, unless otherwise specified and defined, the terms of install, connect and couple, should be construed in their broad meaning, which can be understood as permanent or detachable or integrally connecting, mechanically or electrically connecting, direct connecting or indirect connecting via a third part, or even connecting between the inner parts of two elements. Those skilled in the art could interpret the specific meanings of the above mentioned terms based on the context.

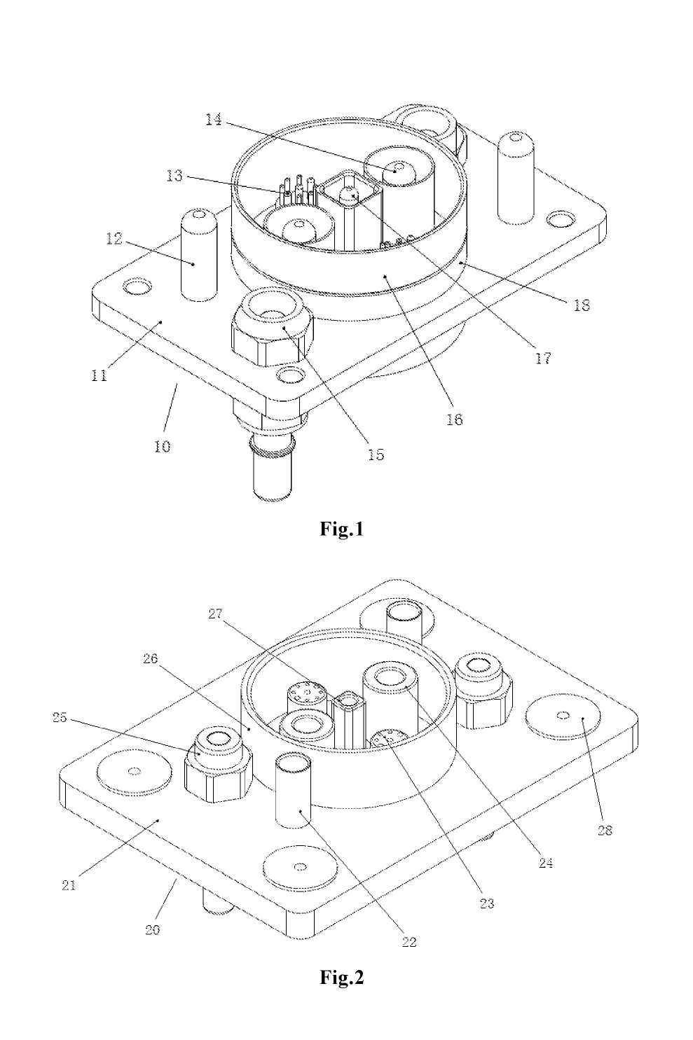

As shown in FIG. 1 and FIG. 2, a connector for liquid cooling battery pack of electric vehicle in accordance with the present application comprises a battery pack end 10 and a wiring harness 20. The battery pack end 10 includes a battery pack end mounting plate 11, two sets of first low voltage terminals 13, two first high voltage terminals 14, two first cooling device interfaces 15, a circular first sealing shell 16, a first grounding terminal 17, and two first guide mechanisms 12 vertically mounted to the mounting plate 11. Each set of first low voltage terminals 13 includes a first low voltage needle-like end (not indicated in the figures) and a second low voltage needle-like end (not indicated in the figures). Preferably, the first needle-like end is constituted by 3 mm terminals used for power supply and grounding, and the second needle-like end is constituted by 1.5 mm terminals used for communication, High Voltage Interlock and wake up signals, etc. Each first cooling device interface 15 is provided with a cut-off valve which as can be contemplated by those skilled in the art, allows cooling liquid to pass through as the interface is connected and prevents cooling liquid from running through as the interface is disconnected. The first sealing shell 16 is provided with a gasket ring 18 at its outside periphery near the battery pack mounting plate 11, which helps the first sealing shell 16 seemingly connected with a second sealing shell 26 (which will be described in detail with reference to FIG. 2). Preferably, each of the first guide mechanism 12 is of cylinder-like structure, yet it is to be understood that it is not limited to cylinder-like structure; a guide mechanism of any structures having guide function such as square column, pin-like shape and wedge can also be suitable for use in the connector.

Still referring to FIG. 1, according to the direction and position shown in FIG. 1, the first grounding terminal 17 is located at the center of the top surface of the battery pack end mounting plate 11, the first sealing shell 16 is of circular-like structure, the center of which coincides with that of the first grounding terminal 17; and the first low voltage terminals 13, the first high voltage terminals 14 and the first grounding terminal 17 are separated from the first guide mechanisms 12 and the first cooling device interfaces 15 by the first sealing shell 16. Specifically, the first low voltage terminals 13, the first high voltage terminals 14 and the first grounding terminal 17 are located within the first sealing shell 16, and the first guide mechanisms 12 and the first cooling device interfaces 15 are located outside the shell 16; the first low voltage terminals 13 and the first high voltage terminals 14 are disposed symmetrically about the central axis of the first grounding terminal 17. Also according to the direction and position shown in FIG. 1, the two sets of first low voltage terminals 13 are located respectively at the front side and back side of the first grounding terminal 17, and the two high voltage terminals 14 are situated respectively at the left and right sides of the terminal 17; the two first guide mechanisms 12 are disposed symmetrically about the center axis of the battery pack end mounting plate 11 and respectively at the back-left and front-right corners of the mounting plate 11, and the two cooling device interfaces 15 are located symmetrically about the center axis of the battery pack end mounting plate 11 and respectively at the front-left and back-right corners of the mounting plat 11.

As can be contemplated by those skilled in the art, Fool-proofing function is also realized for the connector of the present application by disposing the two first guide mechanisms on the same diagonal side of the mounting plate.

As shown in FIG. 2, the wiring harness end 20 and the battery pack end 10 of the connector for liquid cooling battery pack of electric vehicle of the present application are mating with one another. Specifically, the wiring harness end 20 includes a wiring harness end mounting plate 21, two second guide mechanisms 22 vertically mounted to the mounting plate 21 and mating with the first guide mechanisms 12, two sets of second low voltage terminals 23 mating with the two sets of first low voltage terminals 13, two second high voltage terminals 24 mating with the two first high voltage terminals 14, two second cooling device interfaces 25 mating with the two first cooling device interfaces 15, a second circular sealing shell 26 mating with the circular first sealing shell 16 and a second grounding terminal 27 mating with the first grounding terminal 17. Each set of second low voltage terminals 23 includes a first low voltage hole end mating with the first low voltage needle-like end (not indicated in the figures) and a second low voltage hole end mating with the second low voltage needle-like end (not indicated in the figures). Furthermore, the wiring harness end 20 also includes four floating mechanisms 28 mounted to the wiring harness end mounting plate 21.

Still referring to FIG. 2, according to the direction and position shown in FIG. 2, the second grounding terminal 27 is located at the center on the top surface of the wiring harness end mounting plate 21, the second sealing shell 26 is of circular-like structure, the center of which coincides with that of the second grounding terminal 27; and the second low voltage terminals 23, the second high voltage terminals 24 and the second grounding terminal 27 are separated from the second guide mechanisms 22, the second cooling device interfaces 25 and the floating mechanisms 28 by the second sealing shell 26. Specifically, the second low voltage terminals 23, the second high voltage terminals 24 and the second grounding terminal 27 are located within the second sealing shell 26 and the second guide mechanisms 22, the second cooling device interfaces 25 and the floating mechanisms 28 are located outside the shell 26; the second low voltage terminals 23 and the second high voltage terminals 24 are disposed symmetrically about the central axis of the second grounding terminal 27. Also according to the direction and position of the FIG. 2, the two sets of second low voltage terminals 23 are located respectively at the front side and back side of the second grounding terminal 27, and the two high voltage terminals 24 are situated respectively at the left and right sides of the terminal 27; the two second guide mechanisms 22 are disposed symmetrically about the center axis of the wiring harness end mounting plate 21 and respectively at the front-left and back-right corners of the mounting plate 21, and the two second cooling device interfaces 25 are located symmetrically about the center axis of the wiring harness end mounting plate 21 and respectively at the back-left and front-right corners of the mounting plat 21, the floating mechanisms 28 are located respectively at the four corners on the top surface of the wiring harness end mounting plate 21.

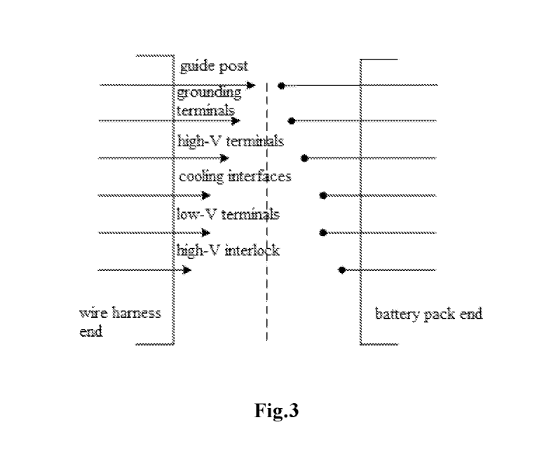

As shown in FIG. 1, FIG. 2 and FIG. 3, the vertical height of the first guide mechanisms 12 is higher than that of the first grounding terminal 17, the vertical height of the first grounding terminal 17 is higher than that of the first high voltage terminals 14, the vertical height of the high voltage terminals 14 is higher than that of the first cooling device interfaces 15, the vertical height of the first cooling device interfaces 15 is the same as that of the first low voltage needle-like ends, and the vertical height of the second low voltage needle-like ends is the shortest.

Still referring to FIG. 1, FIG. 2 and FIG. 3, as can be contemplated by those skilled in the art, when the battery pack end 10 and the wiring harness end 20 of the connector are connected with each other, the first guide mechanisms 12 are the highest in vertical direction and therefore are the first to be inserted into the second guide mechanisms 22, such that the manufacturing and installing tolerance is counteracted and thus other terminals can be successfully connected. As previously mentioned, since both the two first guide mechanisms 12 and the two second guide mechanisms 22 are asymmetrically disposed with reference to the central axis of their respective mounting plates (in other words, disposed on the same side of the diagonal line of the mounting plate), Fooling-proof function is also realized for the connector during connection. The second to be connected are the first grounding terminal 17 at the center on the top surface of the battery pack end mounting plate 11 and the second grounding terminal 27 at the center on the top surface of the wiring harness end mounting plate 21, both of which are used for bringing the battery pack's voltage into the same level as that of the vehicle body and for auxiliary guiding; the next to be connected together are the first high voltage terminals 14 and the second high voltage terminals 24, both of which are used to output and input battery energy, and the top surfaces of the first high voltage terminals 14 are made from insulation material to achieve anti-finger-contact function of IPxxB. Meanwhile, as the first high voltage terminals 14 and the second high voltage terminals 24 are inserted together, the first sealing shell 16 and the second sealing shell 26 are inserted and thus sealingly engaged with one another so as to completely separate the cooling device interfaces from the electrical terminals and therefore achieve water and electricity separation.

With continued reference to FIG. 1, FIG. 2 and FIG. 3, later, four terminals with same vertical heights are connected, that is to say, the two first cooling device interfaces 15 are connected with the two second cooling device interfaces 25 to allow the cooling liquid of the battery pack to circulate. The first low voltage needle-like end is plugged into the first low voltage hole end for the power supply and grounding of the battery pack. The last to be connected together are the second low voltage needle-like end and the second low voltage hole end, which are used for the communication and wake up signals of the battery pack and for detecting the reliability of High Voltage Interlock of the connector. So far, the connector has been assembled, and the assembled connector meets the Protection Class of IP67. As can also be contemplated by those skilled in the art, the disconnecting order of the components of the battery pack end 10 and wiring harness end 20 are carried out in completely reverse order.

It should be pointed out that although the terminals of the battery pack end 10 shown in the FIG. 1 and FIG. 2 are described as male terminals and the terminals of the wiring harness 20 shown in the FIG. 1 and FIG. 2 are described as female terminals, these description is simply exemplary and should not be construed as limitation on this application. Those skilled in the art could design part of the terminals of the battery pack end 10 as female terminals and/or part of the terminals of the wiring harness end 20 as male terminals, and these adjustments do not depart from the general principle of the application and therefore will fall within its protection scope.

In the above embodiments of the connector for liquid cooling battery pack of electric vehicle, the electrical terminals and the cooling device interfaces are integrated on the same mounting plate, and share a set of interface shells, a positioning system, a floating system and a system for detecting the connection, such that the whole connector has the advantages of higher integration level, reduced weight, water and electricity separation, realizing the effects of quickly swapping battery and being much cost effective.

So far, the technical solutions of the present application have been described with reference to the preferred embodiments shown in the accompanying figures. As will be appreciated by those skilled in the art, however, these specific embodiments are not intended to limit protection scope of the application. It will be understood by those skilled in the art that, without departing from the principle of the application, various changes may be made and equivalents may be substituted for related technical features, the varied or substituted technical solutions will fall within protection scope of the invention.

What is claimed is:

1. A connector for liquid cooling battery pack of electric vehicle, comprising mounting plates, electrical terminals, and cooling device interfaces, the electrical terminals and the cooling device being disposed on the mounting plates.

2. The connector for liquid cooling battery pack of electric vehicle according to claim 1, wherein the connector also includes sealing shells disposed on the mounting plates, the electrical terminals are separated from the cooling device interfaces by the sealing shells.

3. The connector for liquid cooling battery pack of electric vehicle according to claim 2, wherein the electrical terminals include high voltage terminals, low voltage terminals and grounding terminals situated within the sealing shells, and the cooling device interfaces are situated outside the sealing shells.

4. The connector for liquid cooling battery pack of electric vehicle according to claim 3, wherein the connector further includes guide mechanisms, which are located on the mounting plates and outside the sealing shells.

5. The connector for liquid cooling battery pack of electric vehicle according to claim 4, wherein the connector further includes floating mechanisms, which are located on the mounting plates and outside the sealing shells.

6. The connector for liquid cooling battery pack of electric vehicle according to claim 5, wherein the connector includes a battery pack end and a wiring harness end, and the mounting plates include a battery pack end mounting plate and a wiring harness end mounting plate.

7. The connector for liquid cooling battery pack of electric vehicle according to claim 6, wherein the high voltage terminals include first high voltage terminals disposed on the battery pack end mounting plate and second high voltage terminals disposed on the wiring harness end mounting plate and mating with the first high voltage terminals.

8. The connector for liquid cooling battery pack of electric vehicle according to claim 7, wherein the low voltage terminals include first low voltage terminals disposed on the battery pack end mounting plate and second low voltage terminals disposed on the wiring harness end mounting plate and mating with the first low voltage terminals.

9. The connector for liquid cooling battery pack of electric vehicle according to claim 8, wherein the grounding terminals include a first grounding terminal disposed on the battery pack end mounting plate and a second grounding terminal disposed on the wiring harness end mounting plate and mating with the first grounding terminal.

10. The connector for liquid cooling battery pack of electric vehicle according to claim 9, wherein the cooling device interfaces include first cooling device interfaces disposed on the battery pack end mounting plate and second cooling device interfaces disposed on the wiring harness end mounting plate and mating with the first cooling device interfaces.

11. The connector for liquid cooling battery pack of electric vehicle according to claim 10, wherein the sealing shells include a first sealing shell disposed on the battery pack end mounting plate and a second sealing shell disposed on the wiring harness end mounting plate and mating with the first sealing shell.

12. The connector for liquid cooling battery pack of electric vehicle according to claim 11, wherein the guide mechanisms include first guide mechanisms disposed on the battery pack end mounting plate and second guide mechanisms disposed on the wiring harness end mounting plate and mating with the first guide mechanisms.

13. The connector for liquid cooling battery pack of electric vehicle according to claim 12, wherein the floating mechanisms are disposed on the wiring harness end mounting plate.

14. The connector for liquid cooling battery pack of electric vehicle according to claim 6, wherein the high voltage terminals, the low voltage terminals, the cooling device interfaces, the sealing shells and the floating mechanisms are disposed on the mounting plates symmetrically with reference to the central axis of their respective mounting plate, and the guide mechanisms are disposed on the mounting plates asymmetrically with reference to the central axis of their respective mounting plate.

15. The connector for liquid cooling battery pack of electric vehicle according to claim 14, wherein the grounding terminals are disposed at the centers of the mounting plates and the centers of the sealing shells.

16. The connector for liquid cooling battery pack of electric vehicle according to claim 12, wherein the first low voltage terminals includes a first low voltage needle-like end and a second low voltage needle-like end, the second low voltage terminals includes a first low voltage hole end mating with the first low voltage needle-like end and a second low voltage hole end mating with the second low voltage needle-like end.

17. The connector for liquid cooling battery pack of electric vehicle according to claim 16, wherein the vertical height of the first guide mechanisms is higher than that of the first grounding terminal, the vertical height of the first grounding terminal is higher than that of the first high voltage terminals, the vertical height of the first high voltage terminals is higher than that of the first cooling device interfaces, the vertical height of the first cooling device interfaces is the same as that of the first low voltage needle-like end, and the vertical height of the first low voltage needle-like end is higher than that of the second low voltage needle-like end.

18. The connector for liquid cooling battery pack of electric vehicle according to claim 17, wherein the first sealing shell is provided with a gasket ring at its periphery in contact with the battery pack end mounting plate; and/or the top surfaces of the first high voltage terminals are made from insulation material; and/or each first cooling device interface is provided with a cut-off valve.
